(19) United States
(12) Patent Application Publication
(10) Pub. No.: US 2005/0050703 A1
(43) Pub. Date: Mar. 10, 2005

(54) Method for routine pit-stop turnaround

(76) Inventor: Austun Kessler, Vallejo, CA (US)

Correspondence Address: CHARLES LOUIS THOEMING, 1990 N. CALIFORNIA BLVD., SUITE 720, WALNUT CREEK, CA, 94596, US

(21) Appl. No.: 10/656,073

(22) Filed: Sep. 5, 2003

(51) Int. Cl. B23P 6/00; B29C 73/00

(52) U.S. Cl. 29/402.08; 29/402.01; 29/402.03; 29/402.11

(57) ABSTRACT

A system for improving routine pit stop turnaround time and safety at a NASCAR or Winston Cup automobile race track employs a hydraulic jack passing method.

### CROSS-REFERENCES TO RELATED APPLICATIONS

None.

### STATEMENT REGARDING FEDERALLY SPONSORED RESEARCH OR DEVELOPMENT

None.

### REFERENCE TO A MICRO-FICHE APPENDIX

None.

### BACKGROUND OF THE INVENTION

1. Field of the Invention

This invention pertains to the field of NASCAR and Winston Cup automobile racing, and more specifically to a novel method for improving the speed and safety of routine pit-stop turnaround for participants in these stock car races.

2. Description of the Related Art

A search of the prior art did not locate any United States patents which are believed to be representative of the present state of the prior art.

NASCAR and Winston Cup automobile racing has become a major source of sporting entertainment in the United States, with track attendance, television revenues, corporate sponsorship of racing teams and cars, and racing prize money increasing steadily each year over the last decade.

Participants in these automobile races vary greatly in terms of financial and personnel resources, driver and equipment support skills, support crew proficiency and efficiency, and marketing publicity. This wide spectrum of variables impacting the success of a particular racing group makes competition in these races a battle of resourcefulness on even the most minute adjustment within the particular participant's limitations as well as the rules.

A principal challenge is the efficient use of time and personnel during racing pit-stops. This challenge is made more acute since many races are won by one or two seconds or fractions of a second. Routine pit stops are understood to be a normal pit stop in the driver or team's assigned pit stall for refueling, minor adjustments, or tire changes. Most racing participants operate with the knowledge that the one thing in most short supply during racing is time. Any time taken while the automobile is in the pits is time lost forever with respect to the racing time line; hence, there is an absolute premium on shortening pit-stop turnaround times. Under present rules for NASCAR or Winston Cup racing routine pit stops, seven pit crew members on the outside of the pit wall synchronize their movements to attend to the needs of the automobile making the pit-stop lasting fourteen seconds, or less.

Seven pit crew members are allowed over the pit wall to attend a racing automobile making a routine pit stop. These seven pit crew members are typically a jackman, two tire changers, two tire carriers, a gasman, and a catch-can man. Tire changes require use of a single, hydraulic jack operated by at least one jackman.

The present method of using a mechanical, hydraulic jack in the pit area for NASCAR or Winston Cup automobile racing involves the jackman carrying the jack around the front of the automobile as it comes to a stop in the pit and lifting then lowering the track side of the automobile, and then returning the jack by again carrying it around the front of the pit stop automobile and lifting and lowering the pit wall side of the automobile. This second manual carrying of the jack around the automobile front end takes at least five seconds and possible as many as nine seconds to accomplish. It also requires the front, pit wall tire carrier to hold back against the pit wall until the jackman has passed back around the front automobile to the pit wall side. Present rules require the same jack to be used for any pit stop involving tire changes. The jackman signals his completion to the driver by dropping the car's pit-wall side when service is complete.

The present method of using the jack as described above also presents safety hazards to the personnel from being exposed to the front of the automobile more than once, possible entanglement of the jackman as he carries the jack in pit pneumatic air hoses or the legs of other pit personnel, possible contact with or rupture of fuel lines or tanks in the automobile in the pit, or potential for being struck by wayward automobiles from the track-side of the pit.

### BRIEF SUMMARY OF THE INVENTION

The invention addresses these limitations in the art and is intended to provide an improved method for hydraulic jack usage thus increasing the safety and turnaround time of pit-stops by solving more of the limitations in a superior manner.

An object of the present invention is to provide a novel and improved method for hydraulic jack usage during NASCAR and Winston Cup automobile racing routine pit stops so as to reduce the time for such activities by a minimum of four seconds.

Another object of the present invention is to provide a novel and improved method for hydraulic jack usage during NASCAR and Winston Cup automobile racing routine pit stops so as to reduce the likelihood of personal injury or accident during the pit-stop.

Yet another object of the present invention is to provide a novel and improved method for hydraulic jack usage during NASCAR and Winston Cup automobile racing routine pit stops so as to reduce health risks to support crew personnel repeatedly undertaking such tasks.

Other features, advantages, and objects of the present invention will become apparent with reference to the following description and accompanying drawings.

### BRIEF DESCRIPTION OF DRAWINGS

FIG. 1 is a top view of the operational paths taken by a NASCAR or Winston Cup automobile racing jackman during a routine pit-stop in the art.

FIG. 2 is a top view of the operational paths taken by a NASCAR or Winston Cup automobile racing jackman during a routine pit-stop according to the method of the present invention.

FIG. 3 is a perspective view of the hydraulic jack pass between jackmen in during a NASCAR or Winston Cup automobile race routine pit-stop according to the method of the present invention.

### DETAILED DESCRIPTION OF THE INVENTION

The following detailed description illustrates the invention by way of example and not by way of limitation. The description clearly enables one skilled in the art to practice the invention, and it describes various embodiments, adaptations, variations, alternatives, and uses of the invention, including what is presently believed to be the best mode of carrying out the invention.

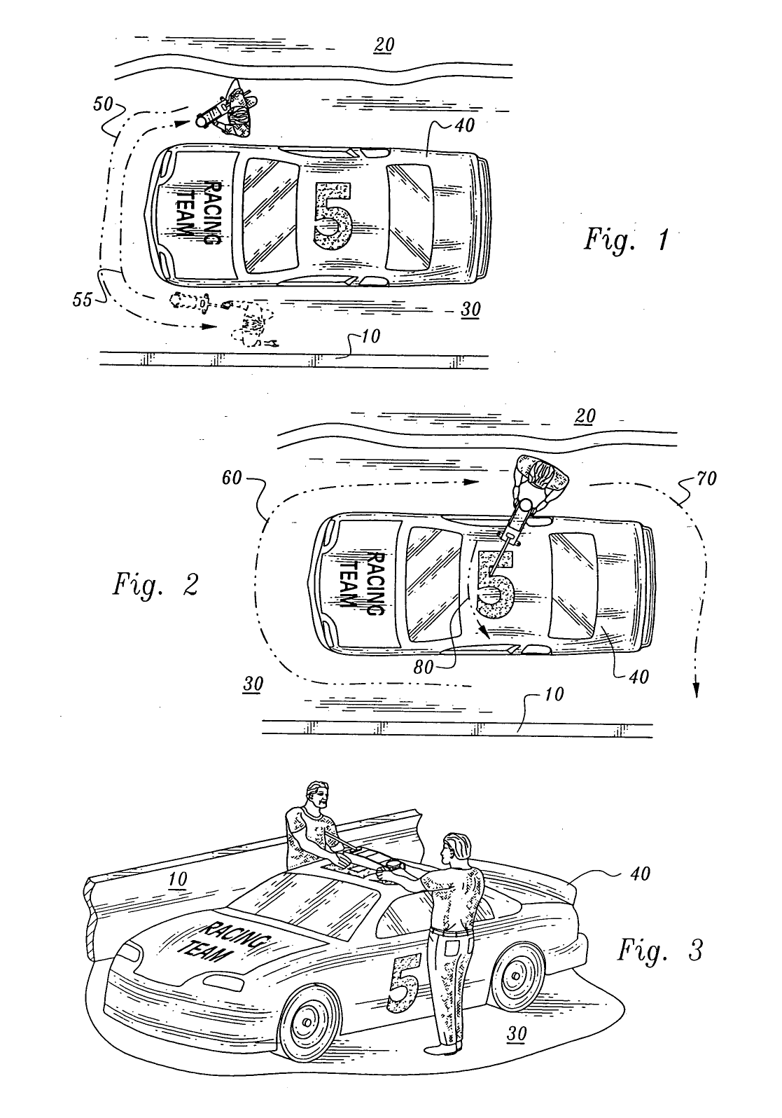

The method of reducing routine pit stop time and improving routine pit stop safety at an automobile race track or a race course of the present invention begins with the standard seven man pit crew as authorized by NASCAR/Winston Cup rules within an assigned pit area, 30, as shown in FIGS. 1 and 2. This pit crew generally includes at least one jackman, two tire changers, two tire carriers, a gasman, and a catch-can man.

As currently practiced in the art, FIG. 1, the jackman manually carries the approved, single hydraulic jack provided by the racing team under NASCAR rules around a pathway 50 in the front of the racing automobile 40 in the pit. The time consuming and cumbersome method presently practiced in the art exposes the pit area equipment and personnel to longer periods on the track side of the automobile 40 in the pit while competing automobiles continue racing on the track 20. The present method also requires tire carriers and changers to remain at the pit wall 10 until the jackman completes the return of the jack to the pit-wall side of the automobile 40 in the pit, costing each of them time in fulfilling their assigned responsibilities during a pit stop.

The method of the present invention includes positioning the first jackman on the track side of a racing automobile after the automobile comes to rest in the pit area, with one side of the automobile towards the track and the other side of the automobile towards the pit wall. The jackman carries the hydraulic jack and moves around the front of the automobile from the pit wall side to the track side as shown by pathway 60 in FIG. 2.

The first jackman continues the method of the present invention by lifting the track side of the automobile using the hydraulic jack until the tires on the track side have been changed by the tire changers. The first jackman then lowers the track side of the automobile by releasing the hydraulic jack.

The first jackman passes the hydraulic jack, handle first, from the track side of the automobile in a passing route 80 over a predetermined portion of the automobile to the second jack man on the pit wall side of the automobile, as depicted in FIGS. 2 and 3. The pass may take place over the hood, roof, or trunk portion of the automobile in the pit, according to the preference of the pit crew and the circumstances presented by the particular track and racing automobile in play, and by the pit stop training and practice routines developed by the pit crew. The weight of the hydraulic jack, while considerably less than standard hydraulic floor jacks, may also be a determinating factor as to the pass location over the automobile. Regardless, it is critical that the pass from the first jackman to the second jackman be handle first, FIG. 3, so as to put the second jackman in proper position to quickly apply the hydraulic jack to the pit wall side of the automobile. Once the hydraulic jack pass has been successfully made from the first jackman to the second jackman, the first jackman can return to the pit wall side of the automobile taking a pathway behind the automobile, 70, as shown in FIG. 3, an exit over the pit wall 10. In this manner, the first jackman is clear of the pit activity taking place on the pit wall side of the automobile and the pit crew working that side of the automobile are not delayed in waiting for the first jackman to be in position.

The second jackman positions the hydraulic jack received from the first jackman and lifts the pit wall side of the automobile using the hydraulic jack until the tires on the pit wall side have been changed by the tire changers. The second jackman then lowers the pit wall side of the automobile by releasing the hydraulic jack, signifying to the automobile driver that the pit stop has been completed and the driver may return to the race track.

As an alternative to the hand-to-hand passing of the hydraulic jack between jackmen, an overhead assist mechanism may be employed within particular track rules or further NASCAR or Winston Cup rule modification for safety considerations. For example, pit area design and equipment may be modified to include a hoist or similar carrier mechanism located on a platform above the automobile in the pit.

The inventive method is not limited to use of auxiliary to platforms extending out above the pit area from the pit wall side of the pit area, but could include platforms on telescoping or otherwise extendable legs.

It will be understood that, while presently preferred embodiments of the invention have been illustrated and described, the invention is not limited thereto, but may be otherwise variously embodied within the scope of the following claims. It will also be understood that the method claims are not intended to be limited to the particular sequence in which the method steps are listed therein, unless specifically stated therein or required by description set forth in the steps.

1. A method of reducing routine pit stop time and improving routine pit stop safety at an automobile race track or a race course, the method comprising the steps of:
providing an assigned pit area;
providing use of a hydraulic jack within the pit area;
providing at least two jackmen within the pit area;
providing at least two tire changers within the pit area;
positioning the first jackman on the track side of a racing automobile after the automobile comes to rest in the pit area, with one side of the automobile towards the track and the other side of the automobile towards the pit wall, by the jackman passing around the front of the automobile from the pit wall side to the track side while carrying the jack;
lifting the track side of the automobile by the first jackman using the hydraulic jack until the tires on the track side have been changed by the tire changers;
lowering the track side of the automobile by the first jackman releasing the hydraulic jack;
passing the hydraulic jack, handle first, from the first jackman on the track side of the automobile over a predetermined portion of the automobile to the second jackman on the pit wall side of the automobile;
lifting the pit wall side of the automobile by the second jackman using the hydraulic jack until the tires on the pit wall side have been changed by the tire changers;
exiting the pit area by the first jackman taking a path behind the automobile and over the pit wall;
lowering the pit wall side of the automobile by the second jackman releasing the hydraulic jack, signifying to the automobile driver that the pit stop has been completed and the driver may return to the race track.

2. The method of claim 1 wherein the predetermined portion of the automobile over which the hydraulic jack is passed is the automobile roof.

3. The method of claim 1 wherein the predetermined portion of the automobile over which the hydraulic jack is passed is the automobile hood.

4. The method of claim 1 wherein the predetermined portion of the automobile over which the hydraulic jack is passed is the automobile trunk.

5. The method of claim 1 wherein passing the hydraulic jack from the first jackman to a second jackman is assisted by use of mechanical means.

6. The method of claim 5 where the mechanical means comprises a hoist supported by a structure above the automobile.

7. The method of claim 6 wherein the structure is a platform.

8. The method of claim 7 wherein the platform is supported by telescoping legs.
